(19) United States
(12) Patent Application Publication
(10) Pub. No.: US 2010/0101203 A1
(43) Pub. Date: Apr. 29, 2010

(54) FEED INJECTOR COOLING JACKET

(75) Inventors: Monty Lee Harned, Sugar Land, TX (US); Douglas Scott Byrd, Greer, SC (US); Judeth Brannon Corry, Manvel, TX (US); Paul Stephen Dimascio, Greer, SC (US); Sunikant Arvindkumar Patel, Sugar Land, TX (US); Shashishekara Sitharamarao Talya, Houston, TX (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/259,631

(22) Filed: Oct. 28, 2008

(51) Int. Cl. F02B 43/00; F02C 1/00; B23P 17/04

(52) U.S. Cl. 60/39.12; 60/740; 29/592

(57) ABSTRACT

A feed injector for providing feed to a gasifier of an integrated gasification combined cycle system includes: a base leading to a body and terminating in a tip, the tip including an exitway for injecting feed into the gasifier; the tip including a mating of an inner shell disposed within a core insert, with an outer shell in which the core insert is disposed; a plurality of spacers disposed between the core insert and inner shell thus providing an inner annular space, and another plurality of spacers disposed between the core insert and outer shell thus providing an outer annular space; the inner annular space and the outer annular space being in fluid communication at the tip and providing for a flow of coolant from the base to the tip and back to the base. A method of fabrication and an integrated gasification combined cycle power plant are also disclosed.

### BACKGROUND OF THE INVENTION

1. Field of the Invention

The invention disclosed herein relates to combustion systems, and in particular to techniques for providing cooling to a feed injector.

2. Description of the Related Art

Many combustion systems, such as those employed by coal gasification facilities, make use of fuel nozzles, also referred to as “feed injectors” and by other similar terms, to supply fuel to a combustion zone.

In many of these combustion systems, feed injectors require cooling during operation to prevent oxidation, corrosion attack, and possible mechanical failure at elevated temperatures. Current methods of cooling accomplishes these requirements, but not to the degree that is desired. In addition, current cooling technologies suffer from difficulties in fabricating the component due to the nature of the material used.

One current method for cooling a feed injector uses helical wrapped coil that covers the aft end of the injector. The coil produces a loose shield that is allowed to expand with the barrel. Unfortunately, the heat transfer and degree of coverage is less than desired with such a device.

Thus, what are needed are improved methods and apparatus for cooling of feed injectors during operation of a combustion system.

### BRIEF DESCRIPTION OF THE INVENTION

In one embodiment of the invention, a feed injector for providing feed to a gasifier of an integrated gasification combined cycle system includes: a base leading to a body and terminating in a tip, the tip including an exitway for injecting feed into the gasifier; the tip including a mating of an inner shell disposed within a core insert, with an outer shell in which the core insert is disposed; a plurality of spacers disposed between the core insert and the inner shell thus providing an inner annular space, and another plurality of spacers disposed between the core insert and the outer shell thus providing an outer annular space; the inner annular space and the outer annular space being in fluid communication at the tip and providing for a flow of coolant from the base to the tip and back to the base.

In another embodiment of the invention, a method for fabricating a feed injector, includes: selecting an outer shell, an inner shell and a core insert; disposing the core insert within the outer shell, thus forming an outer annulus area; disposing the inner shell within the core insert, thus forming an inner annulus area; and mating the outer shell with the inner shell.

In a further embodiment of the invention, an integrated gasification combined cycle (IGCC) power plant, includes: a gasifier including at least one feed injector, the feed injector including a base leading to a body and terminating in a tip, the tip including an exitway for injecting feed into the gasifier, the tip including a mating of an inner shell disposed within a core insert, with an outer shell in which the core insert is disposed, a plurality of spacers disposed between the core insert and the inner shell thus providing an inner annular space, and another plurality of spacers disposed between the core insert and the outer shell thus providing an outer annular space, the inner annular space and the outer annular space being in fluid communication at the tip and providing for a flow of coolant from the base to the tip and back to the base; and a source of coolant provided to one of the outer annular space and the inner annular space and a return for receiving heated coolant through the other one of the outer annular space and the inner annular space. These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of aspects of an Integrated Gasification Combined Cycle (IGCC) power plant;

FIGS. 2, 3 and 4 are cutaway perspective views of a feed injector for use in a gasifier of the IGCC plant of FIG. 1;

FIG. 5 depicts separated components of the feed injector of FIGS. 2-4.

The detailed description explains embodiments of the invention, together with advantages and features, by way of example with reference to the drawings.

### DETAILED DESCRIPTION OF THE INVENTION

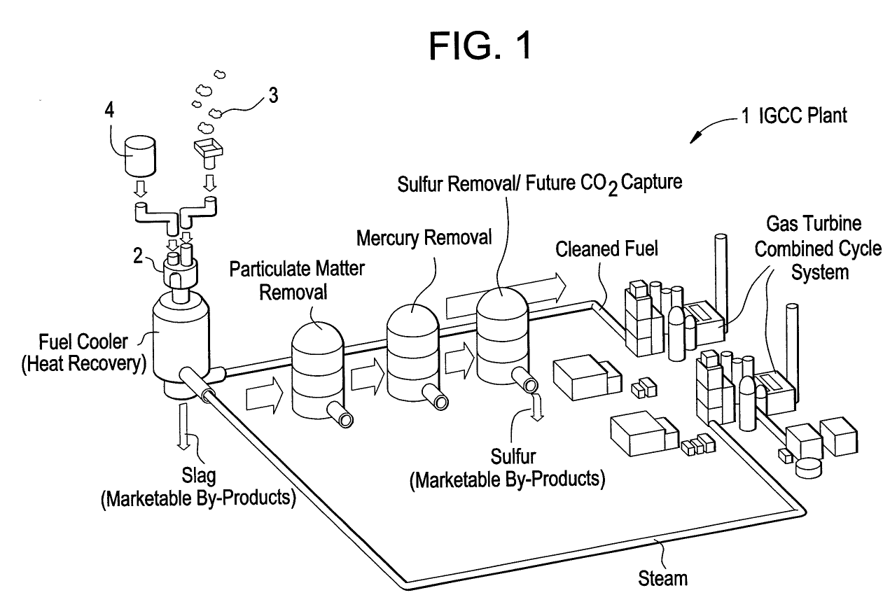

Disclosed is a feed injector that incorporates features for enhanced cooling. In general, the features are unobtrusive and therefore mechanically robust. The feed injector is useful for providing fuel to a variety of combustors, including, for example, and Integrated Gasification Combined Cycle (IGCC) system, aspects of which are depicted in FIG. 1.

With regard to FIG. 1, there are shown aspects of an IGCC process. The IGCC process, referred to as a “clean coal” process, generally emits less than half of the sulfur dioxides, nitrogen oxides, mercury and particulate matter of a traditional pulverized coal plant, making the use of coal for power significantly cleaner. The IGCC process uses less water than a traditional coal burning plant. In some embodiments, the IGCC process provides cleaner emissions by mixing of carbonaceous feed stock(s) with oxygen in a pressurized reaction chamber (gasifier) to produce hot synthesis gas. Water or steam is used with the feed to moderate the reaction temperature. The carbon in the feed is converted to carbon monoxide (CO) and the water/steam to hydrogen (H₂). Depending on the degree of conversion, carbon dioxide (CO₂) and steam (H₂O) will also be present in the synthesis gas along with minor components (e.g. less than 2%—H₂S, CH₄, COS, etc). This synthesis gas, or “syngas,” is then used for a variety of applications including power generation, chemical production, and refining.

A function of the feed injector is to deliver, atomize, and mix the fuel (feed), O₂, and steam/water moderator. The feed injector mixes and atomizes the reactants and controls the fluid flow pattern. Thus, the feed injector is an important component of the gasification technology and may have a high impact on overall process performance (i.e. efficiency), as well as safe and reliable operation.

In the exemplary IGCC plant 1, a gasifier 2 is provided. The gasifier 2 receives an input of at least one of water and steam 3 and mixes the water and/or steam 3 with feed 4 (i.e., fuel). In general, exemplary forms of feed 4 include, solid fuel, such as ground coal and/or petroleum coke mixed with water to make a slurry; oil, such as heavy oils including forms as asphalt and vacuum residual bottoms; as well as gas, such as natural gas and fuel gas.

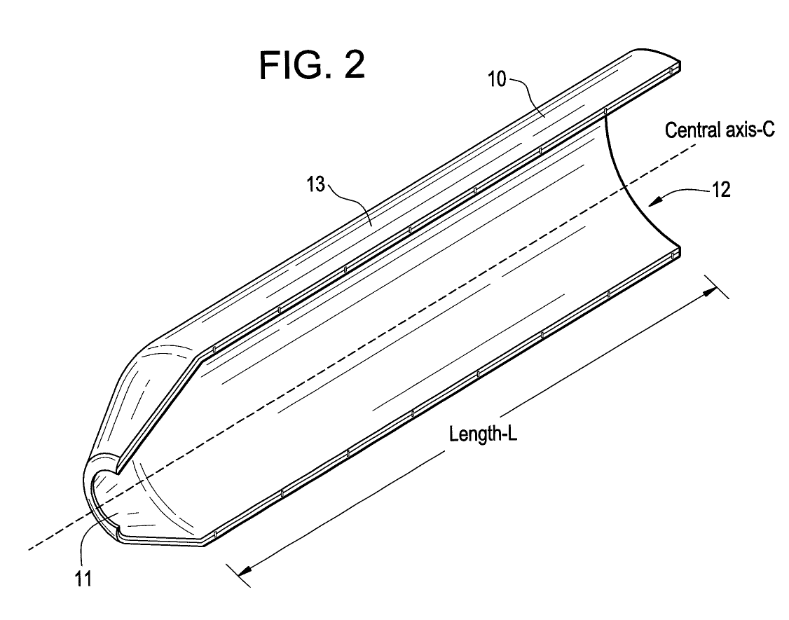

Referring now to FIG. 2, there is shown an overview of aspects of a feed injector 10. In this example, the feed injector 10 includes a body 13, a base 12 and a tip 11. Generally, the tip 11 distributes feed 4 into the gasifier 2. The feed 4 is fed into the feed injector 10 through the base 12. The base 12 may include various mounting components (not shown) such as flanges and couplings as will become apparent with further discussion. The body 13, of a length L, is generally unobstructed and conveys the feed 4 from the base 12 to the tip 11.

In general, the body 12 is of a constant radius, R (refer to FIG. 4), along the length, L, up to a tip section. In the tip section, the body tapers down to an exitway described by the tip 11. In some embodiments, the body 12 is of a varying radius, such as one where the body 12 is slightly tapered along the length, L.

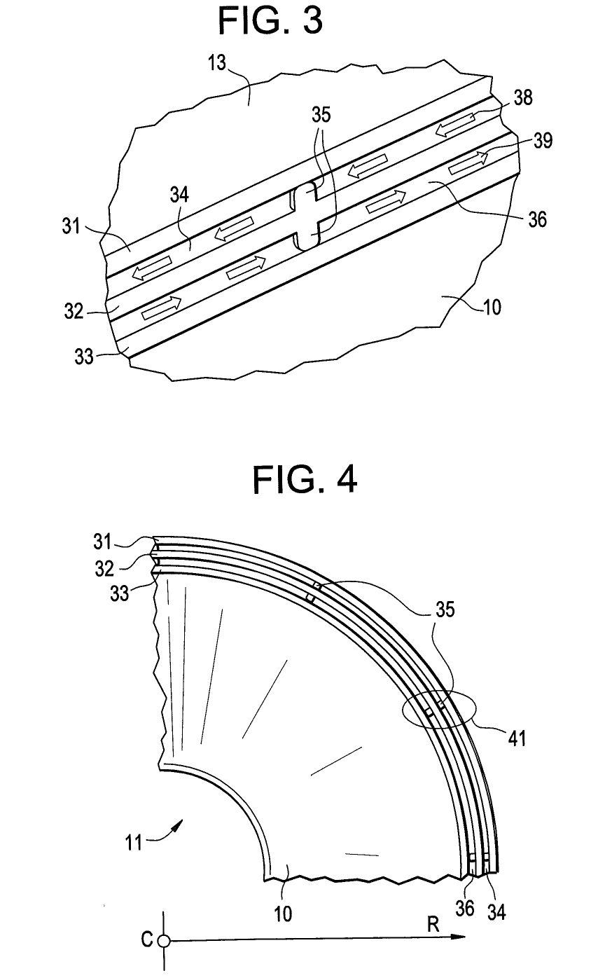

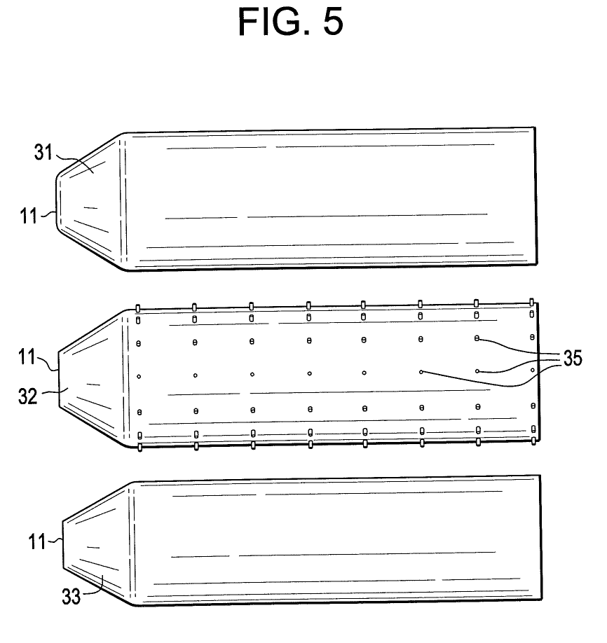

Referring also now to FIG. 3, an exploded view of the cutaway perspective view of FIG. 2 is shown. In this view, the feed injector 10 is shown as including an inner shell 33, a core insert 32 and an outer shell 31. The inner shell 33, core insert 32 and outer shell 31 are concentrically arranged about a central axis, C. In this embodiment, the inner shell 33 provides the unobstructed pathway for feed 4, and is surrounded by the core insert 32. In turn, the core insert 32 is surrounded by the outer shell 31. Separating each of the inner shell 33, core insert 32 and outer shell 31 is a plurality of spacers 35. In this embodiment, the spacers 35 are integrated into each of an outer surface and an inner surface of the core insert 32. The plurality of spacers 35 are sized such that the concentric arrangement of the inner shell 33, core insert 32 and outer shell 31 provides for an inner annular space 36 disposed between the inner shell 33 and the core insert 32, as well as an outer annular space 34 disposed between the outer shell 31 and the core insert 32. The spacers 35 may be disposed on complimentary surfaces, such as an inner surface of the outer shell 31 and an outer surface of the inner shell 33. Various combinations of placements may be used.

In operation, the outer annular space 34 provides for one of an inflow 38 and an outflow 39 of coolant (e.g., pre-injection water) while the inner annular space 36 provides a compliment to the inflow 38 or outflow 39. That is, in operation, coolant may be ported from the base 12 through use of an appropriate porting device into one of the inner annular space 36 and the outer annular space 34. The coolant will travel along the length, L, of the body 13 to the tip 11, and then reverse direction and travel from the tip 11 back toward the base 12. Whether coolant is first introduced into the inner annular space 36 or the outer annular space 34 is a matter of design preference. In this example, as shown in FIG. 3, the inflow 38 travels toward the tip 11 through the outer annular space 34. In this embodiment, the coolant cools the outer shell, and transfers some of the heat to the feed 4, thus pre-heating the feed 4.

Referring now to FIG. 4, a cutaway endview of the feed injector 10 is shown. In this example, the plurality of spacers 35 may be better seen. As may be surmised from this illustration, each spacer 35 provides for ensuring alignment of the inner shell 33, core insert 32 and outer shell 31 along the central axis, C. Accordingly, each of the inner shell 33, core insert 32 and outer shell 31 are of a radius R (as determined from the central axis, C) that ensures each of the inner annular space 36 and the outer annular space 34 are of an adequate size to provide for a desired heat transfer (i.e., will convey an adequate volume of coolant to provide desired cooling effects).

In general, each of the spacers 35 includes a design such that heat transfer is increased. More specifically, the design of each spacer 35 may introduce or encourage turbulence within the coolant. For example, each of the spacers 35 may be of a generally round profile. Other profiles, such as a tear drop shape, a double tear drop shape, a triangular shape, a rectangular shape, and an n-polygonal shape and such may be used. In this example, each of the spacers 35 is realized as a paired spacer 41. That is, at least one spacer 35 appearing in one of the inner annulus area 36 and the outer annulus area 34, a complimentary spacer 35 is provided in the other one of the inner annulus area 36 and the outer annulus area 34. In other embodiments, each of the spacers 35 are individually distributed. For example, in one embodiment, a reduced number of spacers 35 are provided along the inner surface of the core insert 32, such that fewer spacers 35 are realized in the inner annular space 36. Such a design may take into account a strength of materials used in the inner shell 33, core insert 32 and outer shell 31.

Assembly of the feed injector 10 from the inner shell 33, core insert 32 and outer shell 31 may include orbital welding of the inner shell 33 and the outer shell 31 at the tip 11. Other types of welding may be used. For example, manual tig welding, fillet welding, and other types or techniques of welding may be used.

Materials for fabrication of any one of the inner shell 33, the core insert 32 and the outer shell 31 may include, without limitation, a variety of constituents of various alloys. Exemplary materials and design considerations are provided. Chromium, may be used, such as to confer resistance to sulfur compounds and also provide resistance to oxidizing conditions at high temperatures or in corrosive solutions. Nickel may be used, such as to give resistance to corrosion by many organic and inorganic compounds and also to limit chloride-ion stress corrosion cracking (SCC). Alloys with over 40-50% Ni are subject to “green rot” intergranular attack. High Ni alloys, such as one including about 15% Cr and 77% Ni do not have good resistance to high temperature sulfur attack above 1100-1150° F., where Ni rich alloys can form low melting eutectic Ni—Ni₃S₂. Ni is beneficial if there is at least half as much Cr as Ni. Molybdenum may be used, such as in small amounts to add high temperature strength to low chrome steels. Iron may be used to provide resistance to sulfur attack and “green rot” or internal oxidation. 20-25% Fe inhibits “green rot” in high nickel alloys. Cobalt may be used, such as to provide high temperature strength, and may provide other benefits, such as being more resistant to “green rot” (i.e., forms of corrosion) than nickel.

Exemplary materials that may be used include a nickel-chromium-iron alloy, which provides resistance to corrosion and heat. This alloy also has excellent mechanical properties and presents the desirable combination of high strength and good workability; a nickel-chromium-molybdenum alloy, which is a material suited for elevated temperature use in high strength, oxidation problem applications. It also provides corrosion resistance to many acids and resists inter-granular attack and stress-corrosion cracking; various alloys employed in the aerospace industry, such as those that may be used in hot sections of engines in burner cans, ducting and afterburner components; various cobalt alloys which exhibit performance characteristics, such as high degree of corrosion resistance; alloys normally used on feed injector inner/middle tips and is manufactured by a casting process; various cobalt alloys that have excellent thermal impact strength, anti-erosion, and resistance to sulfur vanadium attack; a high-chromium nickel alloy having excellent resistance to many corrosive aqueous media and high-temperature atmospheres, where the high chromium content gives the alloy resistance to aqueous corrosion by oxidizing acids and salts, and to high-temperature sulfidation; a nickel and chromium based filler metal developed for welding, where the higher chromium level provides greater resistance to stress-corrosion cracking, and is also used as an overlay on most low-alloy and stainless steels; and a generally use cobalt alloy that has excellent resistance to many forms of mechanical and chemical degradation over a wide temperature range.

In short, a variety of alloys and superalloys may be used for fabrication of the inner shell 33, the core insert 32 and the outer shell 31. In general, the materials selected for fabrication of the feed injector 10 may be identified by considering such factors as corrosion resistance, limited stress cracking, oxidation resistance, erosion resistance, anti-galling properties, performance in a high-temperature environment, high-temperature hardness, heat conduction properties, machinability, availability and cost.

Having thus described the feed injector 10, certain advantages are provided. For example, the feed injector 10 provides a complete enclosure of a feed injection pathway from the mounting flange (i.e., base 12) to the tip 11. This provides 100% protection from thermal cycles and from attack via corrosion.

The feed injector 10 is easier to fabricate, and thus cooling components may consistently match required specifications. The feed injector 10 also provides a more uniform protection over prior art designs, thus resulting in improved operational characteristics, greater durability, and reduced maintenance. Accordingly, the feed injector 10 disclosed herein is provides reduced cost for manufacturing, operation as well as improved efficiency.

It should be recognized that a multitude of variations of the feed injector 10 may be had. For example, the feed injector 10 may be dimensioned for ensuring efficient injection of a particular type of feed 4. This may include consideration of the radius, R, of the exitway at the tip 11 and such.

The feed injector 10 may be included as a part of a gasifier 2 of an IGCC plant 1. The feed injector 10 may be included as a component in a kit for retrofit of an existing unit, and may include mounting components for direct replacement of prior art feed injection units.

When the feed injector 10 is placed into operation, coolant directed into the annulus areas of the feed injector 10 may be any one or more of a variety of coolant materials. For example, coolant for the feed injector 10 may include, without limitation, water, oil, and other such materials, and may be introduced in forms such as liquid, steam or gas.

Computer modeling may be used along with hand calculations to determine appropriate sizes for annuli and flow rates required for water flow.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A feed injector for providing feed to a gasifier of an integrated gasification combined cycle system, the injector comprising:
a base leading to a body and terminating in a tip, the tip comprising an exitway for injecting feed into the gasifier;
the tip comprising a mating of an inner shell disposed within a core insert, with an outer shell in which the core insert is disposed;
a plurality of spacers disposed between the core insert and the inner shell thus providing an inner annular space, and another plurality of spacers disposed between the core insert and the outer shell thus providing an outer annular space;
the inner annular space and the outer annular space being in fluid communication at the tip and providing for a flow of coolant from the base to the tip and back to the base.

2. The injector of claim 1, wherein the core insert comprises the plurality of spacers disposed on an outer surface.

3. The injector of claim 1, wherein the core insert comprises the another plurality of spacers disposed on an inner surface.

4. The injector of claim 1, wherein at least a portion of the plurality of spacers are paired.

5. The injector of claim 1, wherein the tip comprises a junction between the inner shell and the outer shell.

6. The injector of claim 5, wherein the junction comprises a weld formed by at least one of orbital welding, manual welding and fillet welding.

7. The injector of claim 1, wherein at least one of an inner surface of the outer shell and an outer surface of the inner shell comprise at least one spacer.

8. The injector of claim 1, wherein at least one of the spacers comprises a material selected for at least one of corrosion resistance, limited stress cracking, oxidation resistance, erosion resistance, anti-galling properties, performance in a high-temperature environment, high-temperature hardness, heat conduction properties, machinability, availability and cost.

9. A method for fabricating a feed injector, the method comprising:
selecting an outer shell, an inner shell and a core insert;
disposing the core insert within the outer shell, thus forming an outer annulus area;
disposing the inner shell within the core insert, thus forming an inner annulus area;
and mating the outer shell with the inner shell.

10. The method of claim 9, wherein the mating provides for fluidic communication between the outer annulus area and the inner annulus area.

11. The method of claim 9, further comprising disposing a plurality of spacers on at least one of an inner surface of the outer shell, an outer surface of the core insert, an inner surface of the core insert and an outer surface of the inner shell.

12. The method of claim 9, further comprising selecting at least one of the outer shell, the inner shell and the core insert according to material selected for at least one of corrosion resistance, limited stress cracking, oxidation resistance, erosion resistance, anti-galling properties, performance in a high-temperature environment, high-temperature hardness, heat conduction properties, machinability, availability and cost.

13. The method of claim 9, wherein mating comprises welding.

14. An integrated gasification combined cycle (IGCC) power plant, comprising:
a gasifier comprising at least one feed injector, the feed injector comprising a base leading to a body and terminating in a tip, the tip comprising an exitway for injecting feed into the gasifier, the tip comprising a mating of an inner shell disposed within a core insert, with an outer shell in which the core insert is disposed, a plurality of spacers disposed between the core insert and the inner shell thus providing an inner annular space, and another plurality of spacers disposed between the core insert and the outer shell thus providing an outer annular space, the inner annular space and the outer annular space being in fluid communication at the tip and providing for a flow of coolant from the base to the tip and back to the base; and
a source of coolant provided to one of the outer annular space and the inner annular space and a return for receiving heated coolant through the other one of the outer annular space and the inner annular space.

15. The integrated gasification combined cycle (IGCC) power plant of claim 14, comprising:
a source of feed that provides for mixing of carbonaceous fuel with oxygen in the gasifier to produce a hot synthesis gas.

16. The integrated gasification combined cycle (IGCC) power plant of claim 15, wherein the fuel comprises at least one of a solid fuel, such as at least one of ground coal and petroleum coke mixed with water to make a slurry; oil, such as heavy oils including forms as asphalt and vacuum residual bottoms and gas, such as natural gas and fuel gas.

17. The integrated gasification combined cycle (IGCC) power plant of claim 14, wherein the gasifier comprises a pressurized reaction chamber.
